(19) United States
(12) Patent Application Publication
(10) Pub. No.: US 2007/0278845 A1
(43) Pub. Date: Dec. 6, 2007

(54) Apparatus for mounting a wheel on a vehicle axle

(76) Inventors: Jean-Pierre Vandendriessche, Erpe-Mere (BE); Xavier Bonte, Ijzendijke (NL)

Correspondence Address: CNH AMERICA LLC, INTELLECTUAL PROPERTY LAW DEPARTMENT, PO BOX 1895, M.S. 641, NEW HOLLAND, PA, 17557, US

(21) Appl. No.: 11/809,185

(22) Filed: May 31, 2007

(30) Foreign Application Priority Data
Jun. 2, 2006 (GB) GB 0610769.2

(51) Int. Cl. B60B 1/00

(52) U.S. Cl. 301/35.628

(57) ABSTRACT

A clamping plate 30 is disclose for securing the central disc 24 of a wheel 12 to a wheel flange 14 on an axle 16 of an agricultural vehicle. The flange 14 has a plurality of holes regularly distributed about a pitch circle and the central disc 24 of the wheel and the clamping plate 30 have holes aligned with the holes in the flange 14 for receiving bolts 26 by means of which the central disc 24 of the wheel 12 is clamped between the clamping plate 30 and the flange 14. In the invention, the outer diameter of the clamping plate 30 exceeds the diameter of the pitch circle of the holes in the clamping plate by a distance greater than twice the diameter of the bolts 26.

### FIELD OF THE INVENTION

The present invention relates to apparatus for mounting a wheel on a vehicle axle of a agricultural machine and is particularly though not exclusively applicable to vehicles with dual wheels, these being vehicles in which two wheels are mounted on the same side of an axle.

### BACKGROUND OF THE INVENTION

The wheels of large agricultural machines, such as heavy combine harvesters, are secured to a flange on an axle of the vehicle by using bolts uniformly distributed about the wheel flange to clamp a central disc of the wheel to the flange. A standard pitch diameter and the same size of bolts have been used for many years to allow wheels and wheel shafts to be interchanged. However, as the weight of the vehicles and the size of the tyres have increased over the years, this has placed ever increased loading on the wheel mountings. This increased loading has resulted in failures caused by broken clamping bolts, sheared wheel discs and cracked flanges.

It would be possible to avoid these problems by increasing the pitch diameter and the size of the bolts, but such a solution results in de-standardisation and, for this reason, is not deemed desirable.

The closest prior art to the present invention is believed to be U.S. Pat. No. 4,822,108 which discloses a clamping plate for securing the central disc of a wheel to a wheel flange on an axle of an agricultural vehicle. The flange has a plurality of holes regularly distributed about a pitch circle and the central disc of the wheel and the clamping plate have holes aligned with the holes in the flange for receiving bolts by means of which the central disc of the wheel is clamped between the clamping plate and the flange. The clamping plate in this patent is however a flat thin metal sheet of which the diameter is no greater than that of the flange and it does not overcome the problems outlined above.

### OBJECT OF THE INVENTION

The present invention seeks to mitigate the problems resulting from increased wheel loading while using standard wheel disc and wheel flange geometries, that is to say standard bolt sizes and pitch diameters.

### SUMMARY OF THE INVENTION

According to the present invention, there is provided a clamping plate for securing the central disc of a wheel to a wheel flange on an axle of an agricultural vehicle, wherein the flange has a plurality of holes regularly distributed about a pitch circle and the central disc of the wheel and the clamping plate have holes aligned with the holes in the flange for receiving bolts by means of which the central disc of the wheel is clamped between the clamping plate and the flange, characterised in that the outer diameter of the clamping plate exceeds the diameter of the pitch circle of the holes in the clamping plate by a distance greater than twice the diameter of the bolts.

The present invention is predicated on the realisation that there are two main sources of stress which act on a wheel mounting. The first source is the tensile forces acting on the bolts and this creates a stress zone concentrated around the bolt holes. The second stress source is the bending forces tending to distort the wheel disc out of the plane of the wheel flange and this creates a stress zone concentrated in the region where the outer diameter of the clamping plate contacts the wheel disc.

In the prior art arrangements, these two zones merge into one another and the effect of the two sources of stress is therefore cumulative, which results in the failures mentioned above. However, in the present invention, the distance between the pitch circle of the bolts and the outer circumference of the clamping plate is set sufficiently large to separate the two stress zones so as to avoid overloading the flange, the bolts of the central disc of the wheel.

It is important for the clamping plate to offer high resistance to bending and for this reason it is preferable that it should also extend radially inwards from the pitch circle by a distance exceeding twice the bolt diameter.

Advantageously, the part of the clamping plate lying radially within the pitch circle of the bolt holes is reinforced to resist dishing, such as by the addition of strengthening ribs or by forming the clamping plate as a dome of which the convex sides faces away from the wheel disc.

The clamping plate is preferably formed as a casting but it is alternatively possible for it to be formed of one of more sheets of machined steel.

The invention finds particular application in vehicles with dual wheels because in such vehicles the part of the wheel disc secured to the flange is offset from the central axial plane of the tyre, resulting in an increase in the stresses acting in the second of the two stress zones mentioned above.

### BRIEF DESCRIPTION OF THE DRAWINGS

The invention will now be described further, by way of example, with reference to the accompanying drawings, in which:

FIG. 1 is a section showing two wheels mounted on the same side of an axle,

FIG. 2 shows a detail that is circled in FIG. 1 drawn to an enlarged scale,

FIGS. 3A, 3B and 3C are front, rear and perspective views, respectively of a clamping plate, and

FIG. 4 is a view similar to that of FIG. 1 showing a second embodiment of the invention.

### DETAILED DESCRIPTION OF THE PREFERRED EMBODIMENT(S)

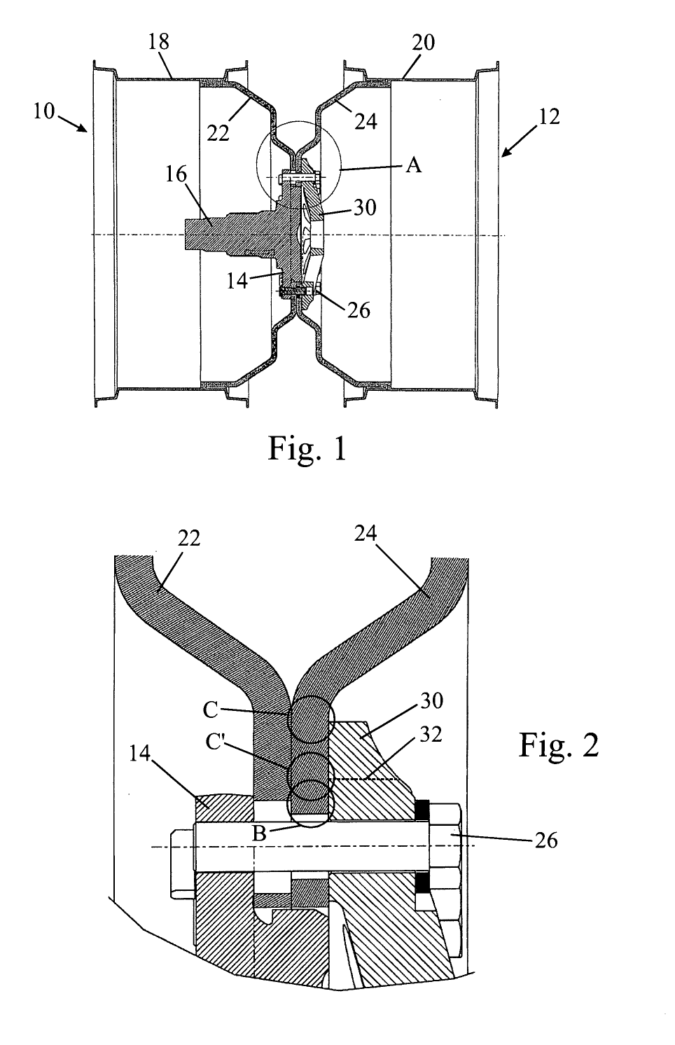

FIG. 1 shows two wheels 10 and 12 mounted on a flange 14 of an axle 16 of a combine harvester. Each wheel is formed of a rim 18, 20 to which the tyre (not shown) is fitted and a disc 22, 24. To allow two wheels to be mounted on the same axle, the discs 22 are dished so that the parts of the discs secured to the flange 14 are offset from the central axial planes of the rims 18 and 20.

The two wheels 10 and 12 are secured to the flange 14 using bolts 26 uniformly distributed about the perimeter of the flange 14. The wheels are mounted by first fitting the inner wheel 10 over the flange, then fitting the outer wheel 12 over the flange so that the disc 22 of the inner wheel is sandwiched between the flange 14 and the disc 24 of the outer wheel. A clamping plate 30, described in more detail below, is then fitted over the disc 24 of the outer wheel and the bolts 26 are screwed into threaded holes in the flange 14 after passing through aligned holes in the clamping plate 30 and the discs 24 and 22 of the two wheels, resulting in the disc 24 of the outer wheel 12 being sandwiched between the clamping plate 30 and the disc 22 of the inner wheel.

As so far described, this form of wheel mounting is known, for example, from U.S. Pat. No. 4,822,108. The invention however differs from the prior art in the function and construction of the clamping plate 30.

To understand the invention more fully, reference will now be made to FIG. 2 which shows the parts within the circle A in FIG. 1 drawn to an enlarged scale. The action of the clamping by the bolts 24 is to create large stresses in the zone marked by a circle B in FIG. 2 surrounding the bolt holes in the disc 24. The weight of the vehicle on the other hand acts to bend the disc 24 and these stresses are concentrated in the zone within a circle C in FIG. 2, centred around the outer circumference of the clamping plate 30.

In the prior art, the clamping plate 30 was dimensioned such that it ended at the position represented by the dotted line 32 in FIG. 2, which caused the stress zone C to be located instead in the zone represented by the circle C′. As the zone B and C′ overlap this caused the two sources of stress to act cumulatively and it is this overloading that has been discovered to be the cause of tearing of the wheel disc 24, shearing of the bolts 26 and cracking of the flange 14.

The present invention avoids this problem by increasing the outer diameter of the clamping plate 30 so as to separate the zones B and C and prevent an accumulation of stress in any part of the disc 24. The distance needed to maintain the desired separation of these two zones is that the outer diameter of the clamping plate 30 needs to be greater than the pitch circle of the bolts 26 by a distance greater than about twice the diameter of the bolts 26.

The plate 30 must have sufficient strength to withstand the forces acting to bend the rim away from the plane of the flange 14. The effects of using such a clamping plate 30 are first that it acts to support the rim of the wheel and to spread the weight induced bending stress over a larger area that is far removed from the bolt holes. Second, the clamping plate acts to spread the stresses caused by the clamping bolts over a large rim area, thereby reducing the stress concentration about the bolt holes. Third, the rigid clamping ring acts to distribute any dynamic loading on one point of the wheel circumference over a larger number of bolts to reduce the loading on the individual bolts. Fourth, the use of a rigid clamping plate allows more accurate alignment of the bolt heads to reduce misalignment stress and, lastly, the clamping plate acts to give extra stiffness to the wheel flange 14 to reduce the risk of cracking.

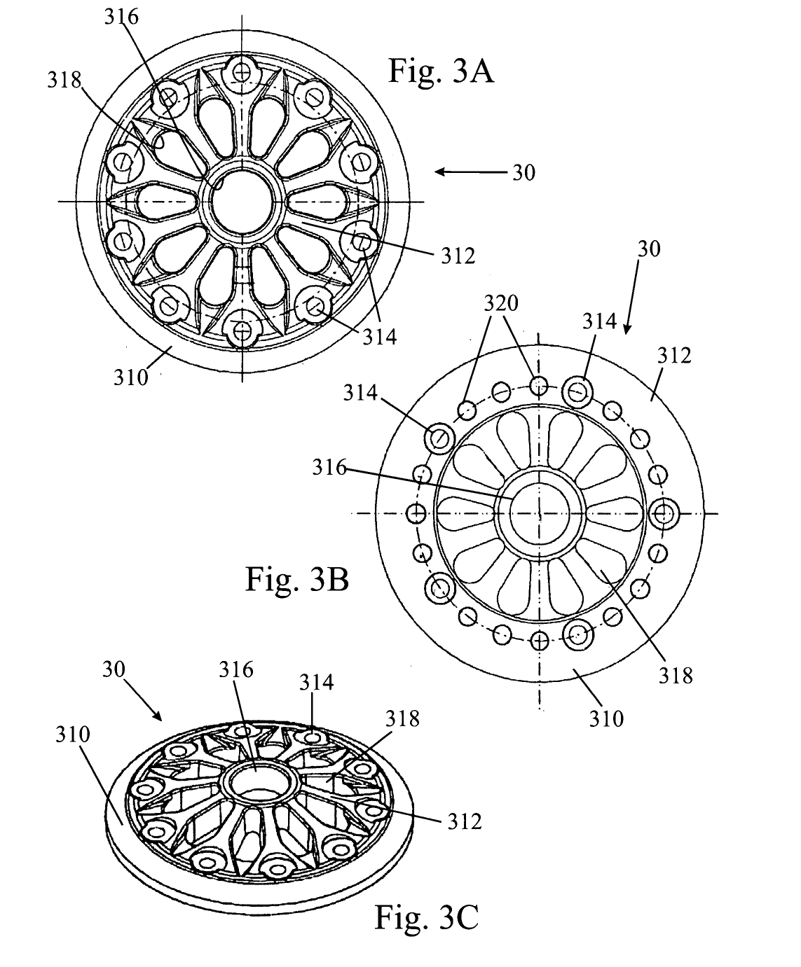

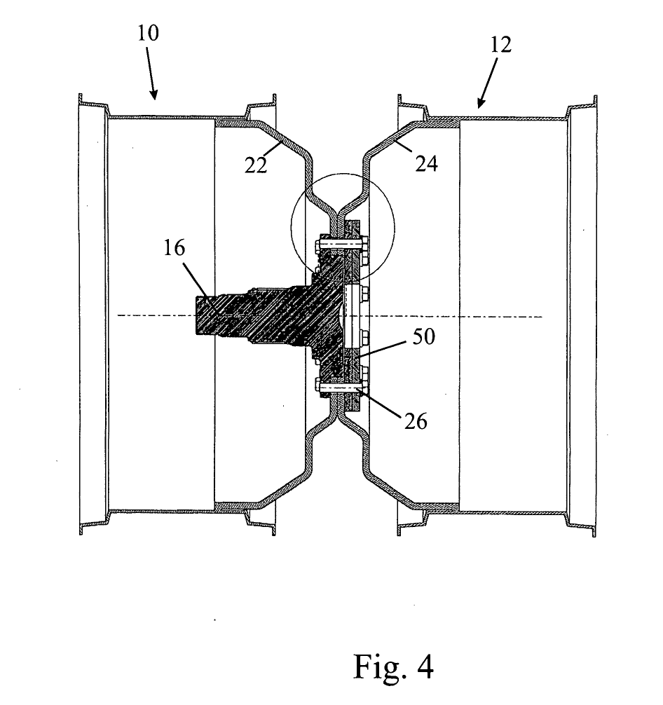

The clamping plate may simply be formed of one or more steel plates as shown at 50 in the embodiment of FIG. 4, but it is preferred to form the clamping plate as a casting having the configuration shown in FIGS. 3A, 3B and 3C. This clamping plate 30 has ten holes 314 for receiving the clamping bolts. The plate 30 has a flat rim 310 lying outside the pitch circle of the holes 314, the rim 310 having a width that is greater than about twice the diameter of the holes 314. The part of the plate 30 inside the pitch diameter of the holes 314 is formed by a dome 312 that has a central hole 316 and ten oval cut outs 318. The central hole 316 and the cut outs 318 are to lighten the component without compromising its rigidity and stiffness. On the reverse side of the plate 30 shown in FIG. 3B, it will be seen that a recess 320 is provided between each pair of bolt holes 314. The purpose of these recesses is to accommodate short studs that project from the flange 14 and serve to position the wheels so that the bolt holes in the two wheels line up correctly with the threaded bolt holes in the flange 14.

Because of the need to withstand bending, the clamping plate 30 cannot be formed of a narrow annulus. As well as the lower limit on its outside diameter specified above, it is also important to place an upper limit on its inside diameter (i.e. the diameter of the hole 316) which should also not approach the pitch diameter of the holes 314 by a distance of less than about twice the diameter of the bolt holes.

Though the invention is intended to allow wheels having a standard configuration of bolt holes to be used on heavier vehicles with larger tyres, wheels specifically intended to be used with a clamping plate of the invention may advantageously be modified to optimise their performance to suit the redistribution of the stresses brought about by the presence of the clamping plate.

1. A clamping plate for securing the central disc of a wheel to a wheel flange on an axle of an agricultural vehicle, wherein the flange has a plurality of holes regularly distributed about a pitch circle and the central disc of the wheel and the clamping plate have holes aligned with the holes in the flange for receiving bolts by means of which the central disc of the wheel is clamped between the clamping plate and the flange, characterised in that the outer diameter of the clamping plate exceeds the diameter of the pitch circle of the holes in the clamping plate by a distance greater than twice the diameter of the bolts.

2. A clamping plate as claimed in claim 1, wherein the plate extends radially inwards from the pitch circle of the bolt holes by a distance exceeding twice the bolt diameter.

3. A clamping plate as claimed in claim 1, wherein the part of the clamping plate lying radially within the pitch circle of the bolt holes is reinforced to resist dishing.

4. A clamping plate as claimed in claim 3, wherein the part of the clamping plate lying radially within the pitch circle of the bolt holes is reinforced by forming the clamping plate as a dome of which the convex side faces away from the wheel disc.

5. A clamping plate as claimed in claim 4, wherein the clamping plate is formed as a casting.

6. A clamping plate as claimed in claim 1, formed of one of more sheets of machined steel.
